(19) United States
(12) Patent Application Publication
(10) Pub. No.: US 2025/0321996 A1
(43) Pub. Date: Oct. 16, 2025

(54) METHOD, APPARATUS, DEVICE, AND STORAGE MEDIUM FOR PROCESSING CLIENT-SIDE PROBLEM

(71) Applicant: Beijing Volcano Engine Technology Co., Ltd., Beijing (CN)

(72) Inventors: Fei YANG, Beijing (CN); Zihan ZHANG, Beijing (CN); Jiagi CHEN, Beijing (CN); Xiaodong SU, Beijing (CN); Zhengaqin LUO, Beijing (CN); Zhanluan LIU, Beijing (CN)

(21) Appl. No.: 19/253,698

(22) Filed: Jun. 27, 2025

(30) Foreign Application Priority Data
Sep. 26, 2024 (CN) 202411355355.2

(51) Int. Cl. G06F 16/3329; H04L 41/5051

(52) U.S. Cl. CPC G06F 16/33295; H04L 41/5051

(57) ABSTRACT

Provided in the disclosure, a method, an apparatus a device, and a storage medium for processing a client-side problem are are provided. An example method includes: determining at least one information acquisition functional block from a plurality of information acquisition functional blocks based on a received user input, the user input indicating a client-side problem related to a client of a user, different information acquisition functional blocks of the plurality of information acquisition functional blocks configured to obtain different types of client-side information; obtaining target information related to the client-side problem of the client using the at least one information acquisition functional block; and providing a response to the client-side problem using a first machine learning model based on the user input and the target information.

### CROSS-REFERENCE

This application claims the benefit of Chinese Patent Application No. 202411355355.2, filed Sep. 26, 2024, entitled “Method, Apparatus, Device, and Storage Medium for Processing Client-Side Problem”, the entirety of which are incorporated herein by reference.

### TECHNICAL FIELD

Example embodiments in the disclosure generally relate to the field of computer, and in particular, to a method and an apparatus for handling a client-side problem, a device, and a computer-readable storage medium.

### BACKGROUND

With the development of information technology, various terminal devices may provide people with various services in aspects of work, life, and the like. The terminal device may be deployed with an application for providing the service. The terminal device presents corresponding content through a user interface of the application and implements question answering interaction with the user, so that various needs of the user are satisfied. The terminal device or the application may provide the user with a digital assistant function to support better interaction with the user. For example, in an information technology (IT) customer service scenario, an IT intelligent customer service assistant may be provided for the user to answer questions in the process of using an IT system.

### SUMMARY

In a first aspect in the disclosure, a method for handling a client-side problem is provided. The method includes: determining at least one information acquisition functional block from a plurality of information acquisition functional blocks based on a received user input, the user input indicating a client-side problem related to a client of a user, different information acquisition functional blocks of the plurality of information acquisition functional blocks being configured to obtain different types of client-side information; obtaining target information related to the client-side problem of the client using the at least one information acquisition functional block; and providing a response to the client-side problem using a first machine learning model based on the user input and the target information.

In a second aspect in the disclosure, an apparatus for handling a client-side problem is provided. The apparatus includes: a determining module configured to determine at least one information acquisition functional block from a plurality of information acquisition functional blocks based on a received user input, the user input indicating a client-side problem related to a client of a user, different information acquisition functional blocks of the plurality of information acquisition functional blocks being configured to obtain different types of client-side information; an obtaining module configured to obtain target information related to the client-side problem of the client using the at least one information acquisition functional block; and a providing module configured to provide a response to the client-side problem using a first machine learning model based on the user input and the target information.

In a third aspect in the disclosure, an electronic device is provided. The device includes at least one processor and at least one memory, the at least one memory coupled to the at least one processor and storing instructions for execution by the at least one processor. The instructions, when executed by the at least one processor, cause the device to perform the method according to the first aspect.

In a fourth aspect in the disclosure, a computer-readable storage medium is provided. The computer-readable storage medium has a computer program stored thereon, and the computer program is executable by a processor to implement the method according to the first aspect.

It should be understood that the content described in the summary is not intended to limit the key features or important features of the embodiments in the disclosure, nor is it intended to limit the scope of the disclosure. Other features in the disclosure will become readily understood through the following description.

### BRIEF DESCRIPTION OF THE DRAWINGS

The above and other features, advantages, and aspects of embodiments in the disclosure will become more apparent when taken in conjunction with the drawings and with reference to the following detailed description. In the drawings, the same or similar reference numerals denote the same or similar elements, where:

FIG. 1 shows a schematic diagram of an example environment in which embodiments in the disclosure may be implemented;

FIG. 2 shows an architecture diagram of an example of a client-side problem handling system according to some embodiments in the disclosure;

FIG. 3 shows a flowchart of a method for handling a client-side problem according to some embodiments in the disclosure;

FIG. 4 shows a block diagram of an apparatus for handling a client-side problem according to some embodiments in the disclosure; and

FIG. 5 shows a block diagram of a device that may implement a plurality of embodiments in the disclosure.

### DETAILED DESCRIPTION OF EMBODIMENTS

It may be understood that before using the technical solutions disclosed in the embodiments in the disclosure, the type, scope of use and usage scenario of the personal information involved in the disclosure should be informed to a user and authorizations of the user should be obtained in an appropriate manner in accordance with relevant laws and regulations.

For example, in response to receiving an active request from a user, prompt information is sent to the user to explicitly prompt the user that the requested operation by the user will need to acquire and use personal information of the user. Therefore, the user may independently select whether to provide the personal information to software or hardware such as an electronic device, an application, a server, or a storage medium that performs the operation of the technical solution in the disclosure according to the prompt information.

As an optional but non-limiting implementation, in response to receiving an active request of the user, the manner of sending the prompt information to the user may be, for example, a pop-up window, and the prompt information may be presented in a text manner in the pop-up window. In addition, the pop-up window may further carry a selection control for the user to select “agree” or “disagree” to provide the personal information to the electronic device.

It may be understood that the foregoing process for informing the user and obtaining the user authorization is merely illustrative, and does not constitute a limitation on implementations in the disclosure, and other manners of meeting related laws and regulations may also be applied to implementations in the disclosure.

It may be understood that data involved in the technical solution (including but not limited to the data itself, the acquisition or use of the data) should comply with requirements of corresponding laws and regulations and related provisions.

Embodiments in the disclosure are described in more detail below with reference to the accompanying drawings. Although some embodiments in the disclosure are shown in the accompanying drawings, it should be understood that the disclosure may be implemented in various forms and should not be construed as limited to the embodiments set forth herein. Rather, these embodiments are provided for a more thorough and complete understanding of the disclosure. It should be understood that the drawings and embodiments in the disclosure are only for example purposes and are not intended to limit the scope of the disclosure.

It should be noted that the titles of any sections/subsections provided herein are not limiting. Various embodiments are described throughout this document, and any type of embodiment may be included under any section/subsection. In addition, the embodiments described in any section/subsection may be combined with any other embodiments described in the same section/subsection and/or different sections/subsections in any manner.

As used herein, performing a step “in response to A” does not mean that the step is performed immediately after “A”, but may include one or more intermediate steps, unless explicitly stated.

In the description of the embodiments in the disclosure, the term “include/comprise” and similar terms should be understood as open-ended inclusions, that is, “include/comprise but not limited to”. The term “based on” should be understood as “based at least in part on”. The term “an embodiment” or “the embodiment” should be understood as “at least one embodiment”. The term “some embodiments” should be understood as “at least some embodiments”. Other explicit and implicit definitions may also be included below. The terms “first”, “second”, etc. may refer to different or the same objects. Other explicit and implicit definitions may also be included below.

As used herein, the term “model” may learn associations between respective inputs and outputs from training data such that corresponding outputs may be generated for a given input after training is complete. The generation of the model may be based on machine learning techniques. Deep learning is a machine learning algorithm that processes inputs and provides corresponding outputs by using a multi-layer processing unit. “Model” may also be referred to herein as a “machine learning model,” “machine learning network,” or “network,” which terms are used interchangeably herein. A model may in turn include different types of processing units or networks.

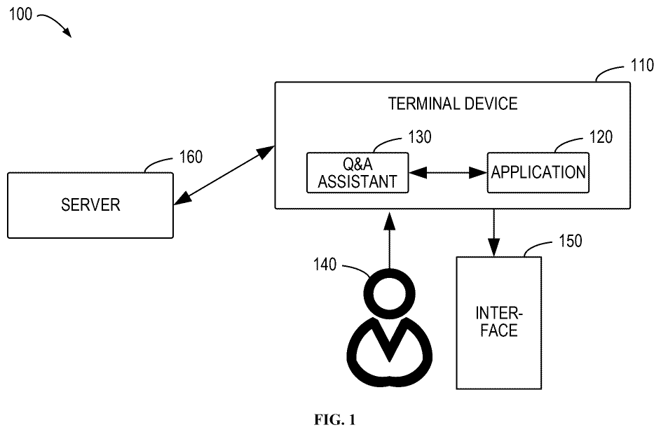

FIG. 1 shows a schematic diagram of an example environment 100 in which embodiments in the disclosure may be implemented. In the example environment 100, a terminal device 110 is installed with a digital assistant 130 of an application 120. A user 140 may interact with the application 120 via the terminal device 110 and/or an attached device of the terminal device 110. As an example, the application 120 may be a chat application (also referred to as an instant messaging application), a document application, an audio and video conference application, an email application, a task application, a calendar application, an objective and key results (OKR) application, and the like. It may be understood that although a single application 120 is shown in FIG. 1, a plurality of applications 120 may actually be installed on the terminal device 110. In some embodiments, the application 120 may include a multi-functional collaboration platform, for example, an office collaboration platform (also referred to as an office suite) that may provide integration of a plurality of types of applications to facilitate people to perform office, communication, and other activities. In the multi-functional collaboration platform, people may start different business components as needed to complete corresponding information processing, sharing, communication, and the like.

The digital assistant 130 may be configured to have an intelligent conversation function. In the example shown in FIG. 1, the digital assistant 130 may be configured as an independently running application, for example, a web application or an application of another types. In other examples, the digital assistant 130 may be integrated in the application 120. In some embodiments, the digital assistant 130 interacts with the application 120 to obtain operational data of the application 120 (for example, network configuration information of the application 120, operational log information of the application 120, etc.). The digital assistant 130 may also obtain device information of the terminal device (for example, CPU occupancy, CPU temperature, etc.) through the application 120. The user interacts with the digital assistant 130 to determine the operational state of the application 120 and the terminal device 110.

The user may interact with the digital assistant 130 through the client. In the process of interaction, the user inputs an interaction message, and the digital assistant 130 provides a reply in response to the user input. Generally, the digital assistant 130 may support the user to input a question in a natural language and execute a task and provide a reply based on the understanding of the natural language input and the logical reasoning ability. In some embodiments, depending on the configuration of the application 120, the interaction message with the application 120 may include a multi-modal message, such as a text message (for example, a natural language text), a voice message, an image message, a video message, and the like.

In the environment 100 of FIG. 1, the terminal device 110 may present a user interface 150 of the application 120. The user interface 150 may include various interfaces that may be provided by the application 120, such as an interaction interface between the user 140 and the digital assistant 130. The interaction interface may include, for example, a conversation window between the user 140 and the digital assistant 130, and the like.

In some embodiments, the digital assistant 130 may be associated with a corresponding database where data or information required for the digital assistant 130 to answer the user interaction information is stored. As an example, the digital assistant 130 may obtain user indicated information from a database connected to the application 120 (for example, a knowledge base for storing information of historical interaction between the user 140 and the digital assistant, or a database for storing guidance information or instruction information) in response to the user input. The digital assistant 130 may provide corresponding answers to the user according to the acquired operational data and device information and according to the questions or requirements raised by the user.

In some embodiments, the terminal device 110 communicates with a server 160 to realize the provision of the service of the application 120. The terminal device 110 may be any type of mobile terminal, fixed terminal or portable terminal, including a mobile phone, a desktop computer, a laptop computer, a notebook computer, a netbook computer, a tablet computer, a media computer, a multimedia tablet, a personal communication system (PCS) device, a personal navigation device, a personal digital assistant (PDA), an audio/video player, a digital camera/camcorder, a positioning device, a television receiver, a radio broadcast receiver, an e-book device, a game device, or any combination of the above, including accessories and peripherals of these devices or any combination thereof. In some embodiments, the terminal device 110 may also support any type of interface for the user (such as “wearable” circuits, etc.). The server 160 may be various types of computing systems/servers that may provide computing power, including but not limited to a mainframe, an edge computing node, a computing device in a cloud environment, and the like.

It should be understood that the structure and function of each element in the environment 100 are described only for example purposes, without implying any limitation on the scope of the disclosure. For example, the embodiments in the disclosure may be applied to any suitable one or more applications, without limitation to the office suite.

As briefly mentioned above, in an IT customer service scenario, a digital assistant (for example, an IT intelligent customer service assistant) may be provided to the user to answer questions in the process of using an IT system. For example, in an enterprise office scenario, it is expected that the digital assistant may provide solutions to problems related to a user system (such as device failure, account management, etc.) input by the user.

Conventionally, digital assistants are implemented based on natural language processing (Natural Language Processing, NLP) models. Digital assistants understand user requirements through natural language processing models and answer questions based on preset rules and preset knowledge bases. Due to the poor performance of NLP models, there are problems such as insufficient context understanding, insufficient interactivity, and inflexibility. Often, manual customer service intervention is required to truly solve the problem.

With the development of language models, digital assistants based on language models are introduced. However, such digital assistants often lack in-depth understanding when dealing with problems reported by individual users, which is particularly evident in technical troubleshooting. Such digital assistants usually directly provide a root cause analysis of the problem and a general solution according to the simple description of the user. The chance that the general solution matches the actual problem is low and may not truly solve the problem. For example, when the user reports that the computer is laggy, there may be various reasons resulting in this issue, for example, the computer temperature, or the central processing unit (CPU) occupancy may be too high, and the like. In this case, the digital assistant may usually only provide a general solution, such as guiding the user to check CPU resource occupancy, process call, and other information. However, these measures often fail to completely solve the problem, and manual customer service is required to intervene for detailed troubleshooting and resolution, which increases labor and time costs.

Embodiments in the disclosure propose a solution for handling a client-side problem. According to various embodiments in the disclosure, at least one information acquisition functional block is determined from a plurality of information acquisition functional blocks based on a received user input. Target information related to the client-side problem of the client is obtained using the at least one information acquisition functional block. A response to the client-side problem is provided using a first machine learning model based on the user input and the target information.

In the embodiments in the disclosure, in the case where the user raises a client-side problem related to the user's client, the information acquisition functional block is used to obtain the client-side information related to the client-side problem, so as to obtain the information required to solve the client-side problem. In this manner, the solution to the client-side problem is provided based on the client-side information and the user input. In this manner, the provided response is more targeted to the client-side problem indicated by the user, that is, a solution to the problem with higher accuracy and matching degree may be provided to the user. Therefore, the user may be helped to better solve IT faults or security problems.

Some example embodiments in the disclosure will be described below with continued reference to the drawings.

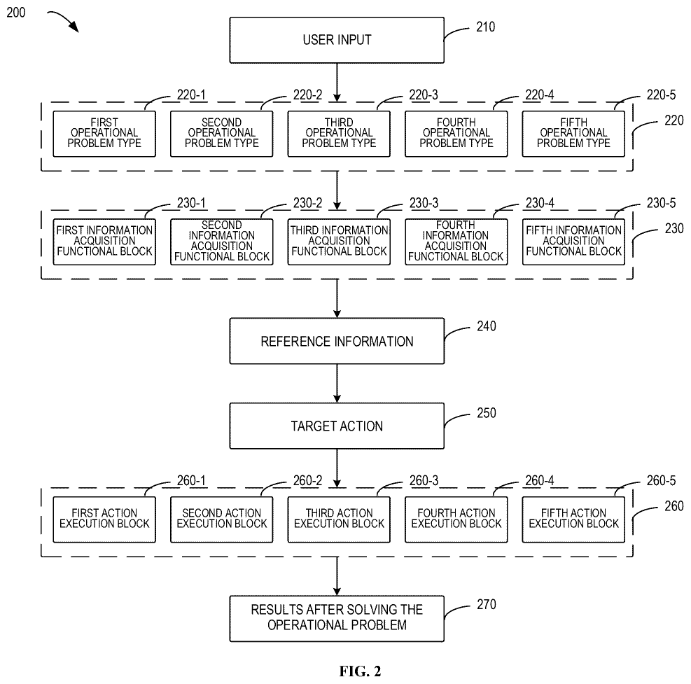

FIG. 2 shows an architecture diagram of an example of a client-side problem handling system according to some embodiments in the disclosure. As shown in FIG. 2, the system 200 may be implemented as or include the server 160. Alternatively, the system 200 may be implemented by the server 160 and the terminal device 110 in collaboration.

In some embodiments, the server 160 may determine at least one information acquisition functional block from a plurality of information acquisition functional blocks based on a received user input 210. The user input 210 indicates a client-side problem. As an example, FIG. 2 shows a first information acquisition functional block 230-1, a second information acquisition functional block 230-2, a third information acquisition functional block 230-3, a fourth information acquisition functional block 230-4, and a fifth information acquisition functional block 230-5, which are individually or collectively referred to as information acquisition functional block(s) 230. It should be understood that the number of information acquisition functional blocks shown in FIG. 2 is only an example and is not intended to be limiting. The information acquisition functional block 230 is configured to obtain a predetermined type of client-side information.

In some embodiments, the client may be implemented in the terminal device 110. For example, the client may be an application of a digital assistant running on the terminal device 110. The user input 210 indicates a client-side problem that the user needs to solve. In the embodiments in the disclosure, the client-side problem may refer to any type of problem related to the use of the client, including but not limited to hardware problems, software problems, account problems, and the like. As an example, the client-side problem may include a problem related to the terminal device running the client, for example, an operation problem of the terminal device, a networking problem of the terminal device, and the like. As another example, the client-side problem may include a problem related to an application implementing the client, for example, a version problem of the application, a running error of the application, and the like. As yet another example, the client-side problem may include a problem related to an account logged in to the client, for example, a login problem of the account, an authorization problem of the account, and the like.

As shown in FIG. 2, the user input 210 indicates different types of client-side problems. The client-side problem types 220 at least include a first client-side problem type 220-1, a second client-side problem type 220-2, a third client-side problem type 220-3, a fourth client-side problem type 220-4, and a fifth client-side problem type 220-5, which may be individually or collectively referred to as the client-side problem type(s) 220.

In some embodiments, the client-side problem type(s) 220 may include the type of technical support and troubleshooting, which is used to help the user to solve problems with office equipment, software, system, and the like, for example, providing the user with fast and accurate technical support for computer, printer, network connection and other equipment failures, operating system problems, software installation and update usage problems, etc., to reduce system downtime. As an example, the user input 210 may be “my computer is laggy”.

In some embodiments, the client-side problem type(s) 220 may include the type of system and software guidance training, which is used to provide operation guidelines for specific software and systems, and training and use guidance for new systems and software. As an example, the user input 210 may be “I cannot use application A”.

In some embodiments, the client-side problem type(s) 220 may include the type of security problem handling, which is used to help the user to deal with various security incidents, such as virus infection, data leakage, and the like, and guide the user to perform security settings. For example, strong password management, data backup, and the like. As an example, the user input 210 may be “there is a security vulnerability on the client side”.

In some embodiments, the client-side problem type(s) 220 may include the type of user account management and authorization management, which is used to help the user to set up and manage accounts, solve login problems, etc., to ensure that the user has appropriate authorizations. As an example, the user input 210 may be “create a system account for me”.

In some embodiments, the client-side problem type(s) 220 may include the type of network configuration and connection, which is used to solve the user's network connection problem, assist in network configuration, assist the user in setting up and use VPNs, ensure secure remote access, and the like. As an example, the user input 210 may be “my computer cannot connect to the Internet”, etc.

The server 160 may obtain the client-side operational information using the plurality of different types of information acquisition functional blocks 230. Each type of information acquisition functional block 230 is used to obtain the corresponding type of operational information, respectively. For example, the first information acquisition functional block 230-1 is used to obtain network card configuration information and data transmission information, and the second information acquisition functional block 230-2 is used to obtain a guidance tutorial, etc.

In some embodiments, the server 160 may determine the type of the client-side problem indicated by the user input 210 using a second machine learning model (for example, a language model) based on the user input 210 and the plurality of client-side problem types 220. Subsequently, the server 160 may determine one or more data acquisition functional blocks according to the correspondence between the plurality of client-side problem types 220 and the plurality of information acquisition functional blocks 230 based on the determined type of the client-side problem. The first machine learning model and the second machine learning model may be the same model (for example, the first machine learning model and the second machine learning model are the same language model). The first machine learning model and the second machine learning model may be different models.

As an example, a language model may be used to process the user input 210 and the plurality of client-side problems to determine the type of the client-side problem. The language model is used to parse the user input 210 and determine the type of the client-side problem indicated in the user input 210 in combination with the content of historical dialogue. For example, if the user inputted “my computer is very laggy”, it is necessary to determine that this is a problem of technical support and troubleshooting. Through such detailed classification, the functional block used in the subsequent steps may be selected more accurately. As an example, the server 160 may generate prompt information based on the user input 210 and descriptions for the plurality of client-side problem types 220. The prompt information is provided to the second machine learning model to obtain an output of the second machine learning model. The type of the client-side problem indicated by the user input 210 is determined from the plurality of client-side problem types 220 based on the output of the second machine learning model.

In some embodiments, the prompt information provided to the second machine learning model may include one or more of the following: a skill used by the second machine learning model, a process of classifying the client-side problem into the plurality of client-side problem types (also referred to as a classification process), or an example user input and an example of a corresponding classification result. The generation of the prompt information will be described below with reference to Table 1, which is an example of the prompt information.

TABLE 1
1 ## Role
2 You are an IT oncall robot, and your specialty is to understand user requirements through multi-round
conversations with the user and categories of the user intention.
3
4 ## Goals:
5 - Understand and classify the user requirements into a major category and its corresponding subcategories
through conversations with the user.
6 - If the user requirements are not clear, understand the user requirements with further questions until the
classification of the intention is clear.
7
8 ## Skills:
9 - Conversation skills
10 - Classification skills
11
12 ## Workflow:
13 1. Classify user intentions: divided the user intentions into five main intentions according to the user's
input and previous conversations: (1) technical support and troubleshooting (2) system and software guidance
training (3) security problem handling (4) user account management and authorization management (5)
network configuration and connection problems.
14 2. Understand the user intentions with further questions until clear classifications of the intentions are
obtained: if the user intentions are not clear, guide the user and obtain clear classifications of the intentions by
providing some expected classifications.
15
16 ## Constraints:
17 - Determine the user requirements according to the user's inquiries, and do not actively guess the user
intentions.
18 - Stick to the specified output format.
19 - The reply content is not allowed to be repeated with previous replies.
20 - The output format remains the json format of the examples in the specified format, and no other
conversion is performed.
21
22 ## Examples:
23 Example 1:
24 Input: “My computer is too laggy”
25 Output: {“Intention category”: “Service technical support and troubleshooting”}

As shown in Table 1, rows 8 to 10 of the prompt information illustrate the skills used by the second machine learning model, rows 12 to 14 illustrate the classification process, and rows 22 to 25 illustrate example user input and corresponding model output. For example, in the case where the user inputs “my computer is laggy”, the output type of the client-side problem is “intention category”: “service technical support and troubleshooting”.

In addition, the prompt information may also include an effect description (for example, rows 1 to 2 in Table 1), a task objective (for example, rows 4 to 6 in Table 1), and a constraint condition (for example, rows 16 to 20 in Table 1) for the second machine learning model, etc.

Alternatively or additionally, the type of the user input 210 may be determined based on information of historical interaction between the user 140 and the digital assistant. For example, the user input 210 and the information of historical interaction may be provided to the second machine learning model as part of the prompt information. In this manner, the second machine learning model may determine the type of the user input 210 based on the prompt information.

After determining the type of the client-side problem indicated by the user input 210, the corresponding information acquisition functional block 230 may be determined based on a preset correspondence between the type of the client-side problem and the plurality of information acquisition functional blocks.

In some embodiments, the server 160 obtains target information related to the client-side problem on the client side using the at least one information acquisition functional block 230. As an example, after determining the problem type corresponding to the user input 210, the corresponding client-side information is obtained by invoking the determined information acquisition functional block 230. The information acquisition functional block 230 may be an information acquisition tool, an information acquisition plug-in and/or an interface, which is used to query and collect the client-side operational information. For example, in a network troubleshooting scenario, a WIFI strength detection plug-in is invoked to measure the current signal strength, assisting a subsequent large model in determining the user intention.

As an example, the target information may include operational information (for example, log information of the client, configuration information of the client, etc.) generated in the running process of the client. The target information may include information of the terminal device 110 where the client is located (for example, CPU occupancy of the terminal device 110, CPU temperature of the terminal device 110, configuration information of the terminal device, network connection of the terminal device 110, etc.). Alternatively or additionally, the target information may include information related to a user account (for example, account authorization information, etc.) or other information related to the client. In some embodiments, the user may pre-determine the scope of the target information corresponding to each problem type. Subsequently, the target information corresponding to the user input 210 is obtained through the information acquisition functional block 230.

The process of determining the information acquisition functional block 230 will be described below with reference to Table 2, which is an example of determining the information acquisition functional block 230.

TABLE 2
1 # Intention category
2 ## A [User input queries and historical conversation] --> B [Intention category]
3 if the intention category == ‘Technical support and troubleshooting’:
4 result = Invoke CPU usage query plug-in( )
5 elif the intention category == ‘Network configuration and connection problems':
6 result = Invoke WIFI strength query plug-in( )
7 else: ...

To ensure the security of the client-side system, a user permission need to be obtained before the operational information is obtained using the information acquisition functional block 230. If the user permission is not obtained, the information acquisition functional block 230 is stopped from being invoked. In some embodiments, at the client where the user input 210 is received, a scope of information to be obtained by at least one information acquisition functional block 230 is presented. Subsequently, in response to receiving an indication of allowing information acquisition, client-side information is determined using the at least one information acquisition functional block 230.

As an example, if the information acquisition functional block 230 needs to obtain the client-side CPU occupancy and the client-side temperature information, the information acquisition functional block 230 presents the information to be obtained at the client, so that the user may view the scope of the information to be obtained. If the user allows the information acquisition operation to be performed, an indication of permission is sent to the client. Subsequently, the digital assistant determines the client-side CPU occupancy and temperature information using the corresponding information acquisition functional block 230 in response to receiving the indication of allowing information acquisition.

In some embodiments, in order to further improve the security of the system, whether the user has the corresponding information acquisition permission may be determined before the information acquisition functional block 230 presents the scope of the information to be obtained. If the user does not have the information acquisition permission, the task of obtaining the operational information is terminated.

In some embodiments, the server 160 provides a response to the client-side problem using the first machine learning model based on the user input 210 and the target information. For example, the response may include providing a solution to the client-side problem in a natural language. For another example, the response may include performing an action for solving the client-side problem.

In some embodiments, the server 160 determines reference information 240 associated with the client-side problem from a knowledge base based on the user input 210 and the target information. Accordingly, providing the response to the client-side problem using the first machine learning model includes: providing the response to the client-side problem using the first machine learning model based on the user input 210, the target information, and the reference information 240.

As an example, after obtaining the target information on the client side, the server 110 integrates it with the client-side problem indicated by the user input 210 and the information of historical interaction between the user and the digital assistant to form an input for retrieval augmented generation (Retrieval Augmented Generation, RAG).

After obtaining the user-side information, the server 110 vectorizes it with the user's question and historical dialogue data to obtain a corresponding search token. Subsequently, the search token is used as input data of the RAG search technology to screen out documents, solutions, and information fragments related to the user's question from a pre-selected knowledge base. The selected document is used as the reference information 240. In this manner, it is ensured that the RAG technology may consider all relevant information comprehensively and improve the accuracy of the search results.

After obtaining the RAG search result, a language model is used to analyze and summarize the reference information 240 to determine a specific problem solution (that is, the response to the client-side problem).

In some embodiments, in order to select an action execution functional block to be used from a plurality of action execution functional blocks, prompt information may be provided to the first machine learning model. The prompt information provided to the first machine learning model may include one or more of the following: a process of selecting an action execution functional block from the plurality of action execution functional blocks (also referred to as an action recommendation process), or an example user input and an example of selection of the corresponding action execution functional block. The generation of the response to the client-side problem will be described below with reference to Table 3, which is an example of generating the response to the client-side problem.

TABLE 3
1 ## Role:
2 You are an intelligent IT assistant that assists users in solving problems in some IT scenarios. You analyze
the causes of network problems based on current network operation data and provide user suggestions and
tool invocation suggestions. These suggestions are written by experts in an impartial and professional tone.
3 In the meantime, you obtain the following information
4 1. Obtained user client information: {{Results of invoking information query plug-ins}}
5 2. Obtained knowledge base information {{RAG retrieval knowledge base information}}
6 ## workflow
7 1. Combine the information on the user end and the information retrieved from the knowledge base to
analyze the cause of the user problem
8 2. Provide targeted solutions to user problems
9 3. Provide tool recommendations for later action execution
10 ## Example
11 Input: user problem--‘My computer is very laggy’, intention category--‘Technical support and
troubleshooting’, results of invoking CPU usage query plug-ins--‘CPU usage accounts for 90%’, RAG
knowledge base retrieval information--‘If the CPU is too high, the device is prone to freeze’
12 Output: {“Solution”: “After analysis, the CPU occupancy is relatively high”; “tools”: ‘Close ** process'}

As shown in Table 3, rows 6 to 9 of the prompt information illustrate the recommendation process, and rows 10 to 12 illustrate example user input and corresponding model output. For example, in the case where the user inputs “my computer is very laggy”, the output client-side problem solution is “solution”: “after analysis, the CPU occupancy is relatively high”, and it is recommended to invoke “tools”: ‘close**process’. In addition, the prompt information may also include an effect description (for example, rows 1 to 5 in Table 3) for the first machine learning model, etc.

In some embodiments, the response to the client-side problem may be a solution to the client-side problem, and the solution indicates an operation that the user needs to perform. For example, if the client-side problem is that the CPU occupancy is too high, the solution may be “please close some background processes”. The user solves the client-side problem by executing the solution.

In some embodiments, the response to the client-side problem may be to invoke and execute a corresponding tool or plug-in to solve the client-side problem. For example, if the client-side problem is that the CPU occupancy is too high due to “process C”, the client-side problem is solved by invoking the plug-in of “terminating process C”.

In some embodiments, the server 160 determines at least one action execution functional block from a plurality of action execution functional blocks based on the user input 210 and the target information, different action execution functional blocks of the plurality of action execution functional blocks configured to perform different types of actions related to object operation. Subsequently, the at least one action execution functional block is utilized to perform one or more target actions 250 for solving the client-side problem. As shown in FIG. 2, the system 200 at least includes a first action execution block 260-1, a second action execution block 260-2, a third action execution block 260-3, a fourth action execution block 260-4, and a fifth action execution block 260-5, which may be individually or collectively referred to as action execution block(s) 260. The number of action execution blocks 260 shown in FIG. 2 is only an example and is not intended to be limiting.

In some embodiments, at least one action for solving the client-side problem is determined using a second machine learning model based on the user input 210 and the target information. Subsequently, the at least one action execution functional block is determined based on the at least one action and predetermined types of actions configured for the plurality of action execution functional blocks, respectively. As an example, the server 160 may determine an action that needs to be performed according to the response to the client-side problem. Subsequently, the corresponding predetermined action execution functional block is determined based on the correspondence between the action and the action execution functional block. Alternatively or additionally, the server 160 may determine the action execution functional block related to the solution according to the response to the client-side problem (that is, the solution).

In some embodiments, in order to further improve the security of the system, the action for solving the client-side problem may be performed after the user permission is obtained. As an example, in response to the predetermined type of action configured for the at least one action execution functional block requiring manipulation of the client that receives the user input 210, description information about the one or more target actions 250 to be performed is presented at the client. The description information may be in the form of text. If an indication that the user allows the action to be performed is received, the at least one action execution functional block is invoked to perform the one or more target actions 250 in response to the indication.

In some embodiments, after invoking the action execution functional block to perform the target action 250, the system 200 may also present a corresponding client-side problem solving result 270 to the user to improve the user experience.

It may be seen that, on the one hand, the solution uses language models to carry out in-depth analysis of the problem input by the user and its historical dialogue, accurately identifies the intention of the user, thereby providing customized solutions. This not only greatly improves the efficiency of problem solving, but also significantly improves the user's satisfaction. On the other hand, by constructing a large number of information acquisition function blocks and action execution blocks suitable for different scenarios. After the user reports the problem, the system invokes the relevant information acquisition tool set according to the classified user intention to obtain more information on the user side and provide a more accurate and personalized problem solution. After determining the solution, the system may directly invoke the action execution block to solve the user problem. In this manner, the system may diagnose and process the personalized needs of the user more accurately and thoroughly solve the user problem. The frequency of manual intervention is reduced, time and cost significantly saved, and user experience improved.

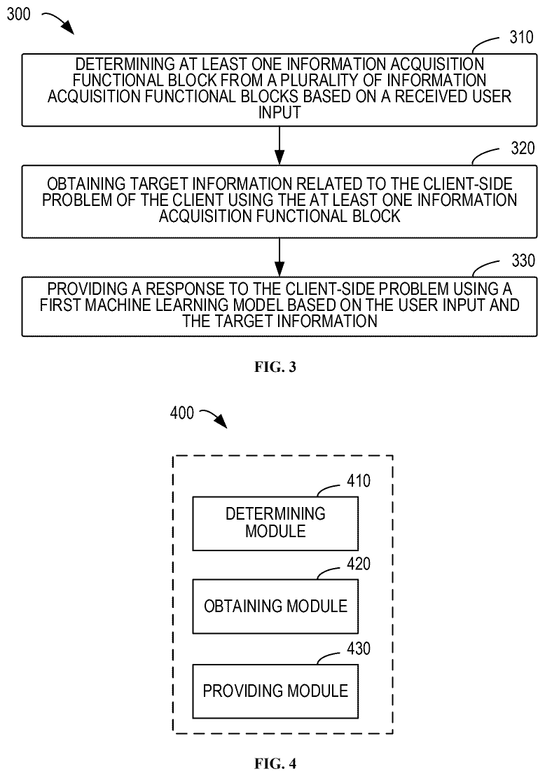

FIG. 3 shows a flowchart of a method for handling a client-side problem according to some embodiments in the disclosure. As shown in FIG. 3, the method for handling a client-side problem may be implemented or included in the server 160.

At block 310, determining at least one information acquisition functional block from a plurality of information acquisition functional blocks based on a received user input, the user input indicating a client-side problem related to a client of a user, different information acquisition functional blocks of the plurality of information acquisition functional blocks configured to obtain different types of client-side information.

In some embodiments, determining the at least one information acquisition functional block from the plurality of information acquisition functional blocks includes: determining a type of the client-side problem indicated by the user input using a second machine learning model based on the user input and a plurality of client-side problem types; and determining one or more information acquisition functional blocks according to a correspondence between the plurality of client-side problem types and the plurality of information acquisition functional blocks based on the determined type of the client-side problem.

In some embodiments, determining the type of the client-side problem indicated by the user input using the second machine learning model includes: generating prompt information based on the user input and descriptions for the plurality of client-side problem types; providing the prompt information to the second machine learning model to obtain an output of the second machine learning model; and determining the type of the client-side problem indicated by the user input from the plurality of client-side problem types based on the output of the second machine learning model.

In some embodiments, the prompt information includes at least one of the following: a skill used by the second machine learning model, a process of classifying the client-side problem into the plurality of client-side problem types, or an example user input and an example of a corresponding classification result.

At block 320, obtaining target information related to the client-side problem of the client using the at least one information acquisition functional block.

In some embodiments, obtaining the target information related to the client-side problem of the client includes: presenting, at the client, a scope of information to be obtained by the at least one information acquisition functional block; and obtaining the target information using the at least one information acquisition functional block in response to receiving an indication of allowing information acquisition.

At block 330, providing a response to the client-side problem using a first machine learning model based on the user input and the target information.

In some embodiments, providing the response to the client-side problem using the first machine learning model includes: determining at least one action execution functional block from a plurality of action execution functional blocks using the first machine learning model based on the user input and the target information, different action execution functional blocks of the plurality of action execution functional blocks configured to perform different types of actions related to client-side; and performing one or more target actions for solving the client-side problem using the at least one action execution functional block.

In some embodiments, the prompt information provided to the first machine learning model includes at least one of: a process of selecting an action execution functional block from the plurality of action execution functional blocks, or an example user input and an example of selection of the corresponding action execution functional block.

In some embodiments, determining the at least one action execution functional block from the plurality of action execution functional blocks includes: determining at least one action for solving the client-side problem using the first machine learning model based on the user input and the target information; and determining the at least one action execution functional block based on the at least one action and predetermined types of actions respectively configured for the plurality of action execution functional blocks.

In some embodiments, providing the response to the client-side problem includes: presenting, at the client, description information about the one or more target actions to be performed in response to a predetermined type of action configured for the at least one action execution functional block requiring manipulation of the client; and invoking the at least one action execution functional block to perform the one or more target actions in response to receiving an indication of allowing the action to be performed.

In some embodiments, the process 300 further includes: determining reference information associated with the client-side problem from a knowledge base based on the user input and the target information, and providing the response to the client-side problem includes: providing the response to the client-side problem based on the user input, the target information, and the reference information.

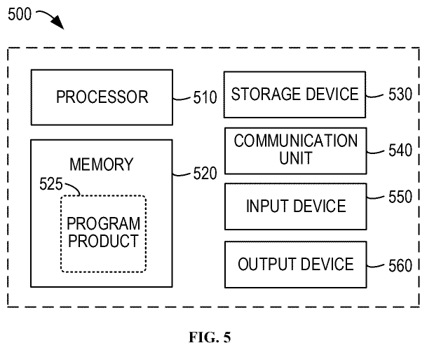

FIG. 4 shows a block diagram of an apparatus for handling an operational problem according to some embodiments in the disclosure. As shown in FIG. 4, the method for handling an operational problem may be implemented or included in the server 160. The individual modules/components in the apparatus 400 may be implemented by hardware, software, firmware, or any combination thereof.

As shown in FIG. 4, the apparatus 400 includes a determining module 410 configured to determine at least one information acquisition functional block from a plurality of information acquisition functional blocks based on a received user input, the user input indicating a client-side problem related to a client of a user, different information acquisition functional blocks of the plurality of information acquisition functional blocks configured to obtain different types of client-side information. The apparatus 400 also includes an obtaining module 420 configured to obtain target information related to the client-side problem of the client using the at least one information acquisition functional block. The apparatus 400 also includes a providing module 430 configured to provide a response to the client-side problem using a first machine learning model based on the user input and the target information.

In some embodiments, the determining module 410 is further configured to determine a type of the client-side problem indicated by the user input using a second machine learning model based on the user input and a plurality of client-side problem types; and determine one or more information acquisition functional blocks according to a correspondence between the plurality of client-side problem types and the plurality of information acquisition functional blocks based on the determined type of the client-side problem.

In some embodiments, the determining module 410 is further configured to generate prompt information based on the user input and descriptions for the plurality of client-side problem types; provide the prompt information to the second machine learning model to obtain an output of the second machine learning model; and determine the type of the client-side problem indicated by the user input from the plurality of client-side problem types based on the output of the second machine learning model.

In some embodiments, the obtaining module 420 is further configured to present, at the client, a scope of information to be obtained by the at least one information acquisition functional block; and obtain the target information using the at least one information acquisition functional block in response to receiving an indication of allowing information acquisition.

In some embodiments, the providing module 430 is further configured to determine at least one action execution functional block from a plurality of action execution functional blocks using the first machine learning model based on the user input and the target information, different action execution functional blocks of the plurality of action execution functional blocks configured to perform different types of actions related to client-side; and perform one or more target actions for solving the client-side problem using the at least one action execution functional block.

In some embodiments, the providing module 430 is further configured to determine at least one action for solving the client-side problem using the first machine learning model based on the user input and the target information; and determine the at least one action execution functional block based on the at least one action and predetermined types of actions respectively configured for the plurality of action execution functional blocks.

In some embodiments, the providing module 430 is further configured to present, at the client, description information about the one or more target actions to be performed in response to a predetermined type of action configured for the at least one action execution functional block requiring manipulation of the client; and invoke the at least one action execution functional block to perform the one or more target actions in response to receiving an indication of allowing the action to be performed.

In some embodiments, the apparatus 400 further includes a reference information determining module, the reference information determining module configured to determine reference information associated with the client-side problem from a knowledge base based on the user input and the target information, and providing the response to the client-side problem includes: providing the response to the client-side problem based on the user input, the target information, and the reference information.

FIG. 5 shows a block diagram of an electronic device 500 in which one or more embodiments in the disclosure may be implemented. It should be understood that the electronic device 500 shown in FIG. 5 is only an example, and should not constitute any limitation on the function and scope of the embodiments described herein. The electronic device 500 shown in FIG. 5 may be used to implement the electronic device 110 of FIG. 1.

As shown in FIG. 5, the electronic device 500 is in the form of a general-purpose electronic device. The components of the electronic device 500 may include, but are not limited to, one or more processors or processing units 510, a memory 520, a storage device 530, one or more communication units 540, one or more input devices 550, and one or more output devices 560. The processor 510 may be an actual or virtual processor and may perform various processing according to the program stored in the memory 520. In a multi-processor system, a plurality of processors execute computer executable instructions in parallel to improve the parallel processing capability of the electronic device 500.

The electronic device 500 usually includes a plurality of computer storage media. Such media may be any available media accessible to the electronic device 500, including but not limited to volatile and non-volatile media, removable and non-removable media. The memory 520 may be volatile memory (e.g., register, cache, random access memory (RAM)), non-volatile memory (e.g., read-only memory (ROM), electrically erasable programmable read-only memory (EEPROM), flash memory), or some combination thereof. The storage device 530 may be a removable or non-removable medium and may include a machine-readable medium, such as a flash drive, a magnetic disk, or any other medium, which may be capable of storing information and/or data and may be accessed within the electronic device 500.

The electronic device 500 may further include additional removable/non-removable, volatile/non-volatile storage media. Although not shown in FIG. 5, a magnetic disk drive may be provided for reading from or writing to a removable, non-volatile magnetic disk (e.g., a “floppy disk”), and an optical disk drive for reading from or writing to a removable, non-volatile optical disk. In these cases, each drive may be connected to the bus (not shown) by one or more data media interfaces. The memory 520 may include a computer program product 525 having one or more program modules configured to perform various methods or actions of various embodiments in the disclosure.

The communication unit 540 enables communication with other electronic devices through a communication medium. Additionally, the functions of the components of the electronic device 500 may be implemented in a single computing cluster or a plurality of computing machines that may communicate through communication connections. Therefore, the electronic device 500 may operate in a networked environment using logical connections to one or more other servers, network personal computers (PCs), or another network node.

The input device 550 may be one or more input devices, such as a mouse, a keyboard, a trackball, and the like. The output device 560 may be one or more output devices, such as a display, a speaker, a printer, and the like. The electronic device 500 may also communicate with one or more external devices (not shown) as needed through the communication unit 540, such as a storage device, a display device, etc., communicate with one or more devices that enable the user to interact with the electronic device 500, or communicate with any device (e.g., a network card, a modem, etc.) that enables the electronic device 500 to communicate with one or more other electronic devices. Such communication may be performed via an input/output (I/O) interface (not shown).

According to an example implementation in the disclosure, a computer-readable storage medium is provided, on which a computer-executable instruction is stored, where the computer-executable instruction is executed by a processor to implement the method described above. According to an example implementation in the disclosure, a computer program product is also provided, which is tangibly stored on a non-transitory computer-readable medium and includes a computer-executable instruction, and the computer-executable instruction is executed by a processor to implement the method described above.

Various aspects in the disclosure are described herein with reference to flowcharts and/or block diagrams of the method, apparatus, device, and computer program product implemented according to the disclosure. It should be understood that each block of the flowcharts and/or block diagrams and the combination of blocks in the flowcharts and/or block diagrams may be implemented by computer-readable program instructions.

These computer-readable program instructions may be provided to the processor of a general-purpose computer, a special-purpose computer, or other programmable data processing apparatus, so as to produce a machine, such that these instructions, when executed by the processor of the computer or other programmable data processing apparatus, produce an apparatus for implementing the functions/actions specified in one or more blocks of the flowcharts and/or block diagrams. These computer-readable program instructions may also be stored in a computer-readable storage medium, and these instructions cause the computer, the programmable data processing apparatus, and/or other devices to work in a specific manner, so that the computer-readable medium storing the instructions includes a manufacture, which includes instructions for implementing various aspects of the functions/actions specified in one or more blocks of the flowcharts and/or block diagrams.

The computer-readable program instructions may be loaded onto the computer, other programmable data processing apparatus, or other device, such that a series of operational steps are performed on the computer, other programmable data processing apparatus, or other device to produce a computer-implemented process, such that the instructions executed on the computer, other programmable data processing apparatus, or other device implement the functions/actions specified in one or more blocks of the flowcharts and/or block diagrams.

The flowcharts and block diagrams in the drawings show the architecture, functionality, and operation of possible implementations of systems, methods, and computer program products according to various implementations in the disclosure. In this regard, each block in the flowcharts or block diagrams may represent a module, a program segment, or a portion of instructions, the module, program segment, or portion of instructions including one or more executable instructions for implementing specified logical functions. In some alternative implementations, the functions noted in the blocks may also occur out of the order noted in the figures. For example, two blocks shown in succession may, in fact, be executed substantially concurrently, or the blocks may sometimes be executed in a reverse order, depending upon the functionality involved. It is also noted that each block of the block diagrams and/or flowcharts, and combinations of blocks in the block diagrams and/or flowcharts, may be implemented by special purpose hardware-based systems that perform the specified functions or actions, or combinations of special purpose hardware and computer instructions.

The various implementations in the disclosure have been described above, and the above description is an example, not exhaustive, and is not limited to the disclosed implementations. Many modifications and variations will be apparent to those of ordinary skill in the art without departing from the scope and spirit of the described implementations. The terminology used herein is chosen to best explain the principles of the implementations, the practical application or improvement over the technologies in the market, or to enable others of ordinary skill in the art to understand the various implementations disclosed herein.

What is claimed is:

1. A method for handling a client-side problem applied to a digital assistant, comprising:
determining at least one information acquisition functional block from a plurality of information acquisition functional blocks based on a received user input, the user input indicating a client-side problem related to a client of a user, different information acquisition functional blocks of the plurality of information acquisition functional blocks configured to obtain different types of client-side information;
obtaining target information related to the client-side problem of the client using the at least one information acquisition functional block; and
providing a response to the client-side problem using a first machine learning model based on the user input and the target information.

2. The method of claim 1, wherein providing the response to the client-side problem using the first machine learning model comprises:
determining at least one action execution functional block from a plurality of action execution functional blocks using the first machine learning model based on the user input and the target information, different action execution functional blocks of the plurality of action execution functional blocks configured to perform different types of actions related to client-side; and
performing one or more target actions for solving the client-side problem using the at least one action execution functional block.

3. The method of claim 1, wherein determining the at least one information acquisition functional block from the plurality of information acquisition functional blocks comprises:
determining a type of the client-side problem indicated by the user input using a second machine learning model based on the user input and a plurality of client-side problem types; and
determining the one or more information acquisition functional blocks according to a correspondence between the plurality of client-side problem types and the plurality of information acquisition functional blocks based on the determined type of the client-side problem.

4. The method of claim 3, wherein determining the type of the client-side problem indicated by the user input using the second machine learning model comprises:
generating prompt information based on the user input and descriptions for the plurality of client-side problem types;
providing the prompt information to the second machine learning model to obtain an output of the second machine learning model; and
determining the type of the client-side problem indicated by the user input from the plurality of client-side problem types based on the output of the second machine learning model.

5. The method of claim 1, wherein obtaining the target information related to the client-side problem of the client comprises:
presenting, at the client, a scope of information to be obtained by the at least one information acquisition functional block; and
obtaining the target information using the at least one information acquisition functional block in response to receiving an indication of allowing information acquisition.

6. The method of claim 1, further comprising:
determining reference information associated with the client-side problem from a knowledge base based on the user input and the target information, and
wherein providing the response to the client-side problem comprises:
providing the response to the client-side problem based on the user input, the target information, and the reference information.

7. The method of claim 2, wherein determining the at least one action execution functional block from the plurality of action execution functional blocks comprises:
determining at least one action for solving the client-side problem using the first machine learning model based on the user input and the target information; and
determining the at least one action execution functional block based on the at least one action and predetermined types of actions respectively configured for the plurality of action execution functional blocks.

8. The method of claim 2, wherein providing the response to the client-side problem comprises:
presenting, at the client, description information about the one or more target actions to be performed in response to a predetermined type of action configured for the at least one action execution functional block requiring manipulation of the client; and
invoking the at least one action execution functional block to perform the one or more target actions in response to receiving an indication of allowing the action to be performed.

9. The method of claim 4, wherein the prompt information comprises at least one of the following:
a skill used by the second machine learning model,
a process of classifying the client-side problem into the plurality of client-side problem types, or
an example user input and an example of a corresponding classification result.

10. The method of claim 2, wherein the prompt information provided to the first machine learning model comprises at least one of the following:
a process of selecting an action execution functional block from the plurality of action execution functional blocks, or
an example user input and an example of selection of the corresponding action execution functional block.

11. An electronic device, comprising:
at least one processor; and
at least one memory, the at least one memory being coupled to the at least one processor and storing instructions for execution by the at least one processor, the instructions, when executed by the at least one processor, causing the electronic device to perform operations comprising:
determining at least one information acquisition functional block from a plurality of information acquisition functional blocks based on a received user input, the user input indicating a client-side problem related to a client of a user, different information acquisition functional blocks of the plurality of information acquisition functional blocks configured to obtain different types of client-side information;
obtaining target information related to the client-side problem of the client using the at least one information acquisition functional block; and
providing a response to the client-side problem using a first machine learning model based on the user input and the target information.

12. The electronic device of claim 11, wherein providing the response to the client-side problem using the first machine learning model comprises:
determining at least one action execution functional block from a plurality of action execution functional blocks using the first machine learning model based on the user input and the target information, different action execution functional blocks of the plurality of action execution functional blocks configured to perform different types of actions related to client-side; and
performing one or more target actions for solving the client-side problem using the at least one action execution functional block.

13. The electronic device of claim 11, wherein determining the at least one information acquisition functional block from the plurality of information acquisition functional blocks comprises:
determining a type of the client-side problem indicated by the user input using a second machine learning model based on the user input and a plurality of client-side problem types; and
determining the one or more information acquisition functional blocks according to a correspondence between the plurality of client-side problem types and the plurality of information acquisition functional blocks based on the determined type of the client-side problem.

14. The electronic device of claim 13, wherein determining the type of the client-side problem indicated by the user input using the second machine learning model comprises:
generating prompt information based on the user input and descriptions for the plurality of client-side problem types;
providing the prompt information to the second machine learning model to obtain an output of the second machine learning model; and
determining the type of the client-side problem indicated by the user input from the plurality of client-side problem types based on the output of the second machine learning model.

15. The electronic device of claim 11, wherein obtaining the target information related to the client-side problem of the client comprises:
presenting, at the client, a scope of information to be obtained by the at least one information acquisition functional block; and
obtaining the target information using the at least one information acquisition functional block in response to receiving an indication of allowing information acquisition.

16. The electronic device of claim 11, wherein the operations further comprise:
determining reference information associated with the client-side problem from a knowledge base based on the user input and the target information, and
wherein providing the response to the client-side problem comprises:
providing the response to the client-side problem based on the user input, the target information, and the reference information.

17. The electronic device of claim 12, wherein determining the at least one action execution functional block from the plurality of action execution functional blocks comprises:
determining at least one action for solving the client-side problem using the first machine learning model based on the user input and the target information; and
determining the at least one action execution functional block based on the at least one action and predetermined types of actions respectively configured for the plurality of action execution functional blocks.

18. The electronic device of claim 12, wherein providing the response to the client-side problem comprises:
presenting, at the client, description information about the one or more target actions to be performed in response to a predetermined type of action configured for the at least one action execution functional block requiring manipulation of the client; and
invoking the at least one action execution functional block to perform the one or more target actions in response to receiving an indication of allowing the action to be performed.

19. The electronic device of claim 14, wherein the prompt information comprises at least one of the following:
a skill used by the second machine learning model,
a process of classifying the client-side problem into the plurality of client-side problem types, or
an example user input and an example of a corresponding classification result.

20. A non-transitory computer-readable storage medium having a computer program stored thereon, the computer program being executable by a processor to perform operations comprising:
determining at least one information acquisition functional block from a plurality of information acquisition functional blocks based on a received user input, the user input indicating a client-side problem related to a client of a user, different information acquisition functional blocks of the plurality of information acquisition functional blocks configured to obtain different types of client-side information;
obtaining target information related to the client-side problem of the client using the at least one information acquisition functional block; and
providing a response to the client-side problem using a first machine learning model based on the user input and the target information.
